(19) United States
(12) Patent Application Publication
(10) Pub. No.: US 2010/0325481 A1
(43) Pub. Date: Dec. 23, 2010

(54) DEVICE HAVING REDUNDANT CORE AND A METHOD FOR PROVIDING CORE REDUNDANCY

(75) Inventors: Odi Dahan, Oranit (IL); Ori Goren, Kibutz Ruchama (IL); Yossy Neeman, Gedera (IL)

Correspondence Address: LARSON NEWMAN & ABEL, LLP, 5914 WEST COURTYARD DRIVE, SUITE 200, AUSTIN, TX, 78730, US

(73) Assignee: Freescale Semiconductor, Inc., Austin, TX (US)

(21) Appl. No.: 12/446,409

(22) PCT Filed: Oct. 20, 2006
(86) PCT No.: PCT/IB06/53874

§ 371 Date: Apr. 20, 2009

(51) Int. Cl. G06F 11/20

(52) U.S. Cl. 714/10; 714/E11.071

(57) ABSTRACT

A device and a method for providing core redundancy, the device includes: multiple cores; a core operability unit adapted to indicate an operability of each core out of the multiple cores; and a core control signal unit adapted to provide mapping signals that comprise virtual core to physical core mapping signals and physical core to virtual core mapping signals; wherein each core out of the multiple cores comprises at least one interrupt interface, and a crossbar interface which are responsive to at least one mapping signal.

### FIELD OF THE INVENTION

The present invention relates to a device having redundant cores and to a method for providing core redundancy.

### BACKGROUND OF THE INVENTION

Many modern integrated circuits include multiple processor cores (also referred to as cores). Defining a whole integrated circuit as defective because of a single defective core can dramatically reduce the yield of such integrated circuits. In many cases these integrated circuits can operate when not all of their cores are operable. Although a non-operable core can decrease the performance of the integrated circuit that can still be of value.

Many integrated circuits connect multiple cores to a highly complex crossbar that is also connected to various components of the integrated circuit. A malfunctioning core that is connected to a crossbar can cause crossbar routing problems as well as memory space re-use issues.

There is a need to provide an efficient device and a method for providing core redundancy, especially in an integrated circuit that includes multiple cores and a crossbar.

### SUMMARY OF THE PRESENT INVENTION

A device having redundant cores and a method for providing core redundancy, as described in the accompanying claims.

### BRIEF DESCRIPTION OF THE DRAWINGS

The present invention will be understood and appreciated more fully from the following detailed description taken in conjunction with the drawings in which:

FIG. 1 illustrates a device according to an embodiment of the invention;

FIG. 2 illustrates a virtual to physical core multiplex logic, according to an embodiment of the invention;

FIG. 3 illustrates a physical to virtual core multiplex logic, according to an embodiment of the invention;

FIG. 4 illustrates a core identification logic, according to an embodiment of the invention;

FIG. 5 illustrates an interconnect connected to the multiple cores, according to an embodiment of the invention; and

FIG. 6 illustrates a method for providing core redundancy, according to an embodiment of the invention.

### DETAILED DESCRIPTION OF PREFERRED EMBODIMENTS

The following figures illustrate exemplary embodiments of the invention. They are not intended to limit the scope of the invention but rather assist in understanding some of the embodiments of the invention. It is further noted that all the figures are out of scale.

A device and system that enable core redundancy by having physical cores act as virtual cores. Accordingly, if one or more core and non-operative, the traffic to a non-operable core can be re-routed to another physical core that replaces the non-operable core. By using virtual identification numbers, the exchange of cores does not require to alter an application that is being executed by the cores.

It is noted that the relationships between physical cores and virtual cores can be represented in various manners. These relationships can be represented by mapping signals that include virtual core to physical core mapping signals and physical core to virtual core mapping signals. These relationships can also be represented by pairs of physical core identification numbers and virtual core identification numbers. Conveniently, a virtual identification number of a core can be response to an operability of at least one other core of the multiple cores.

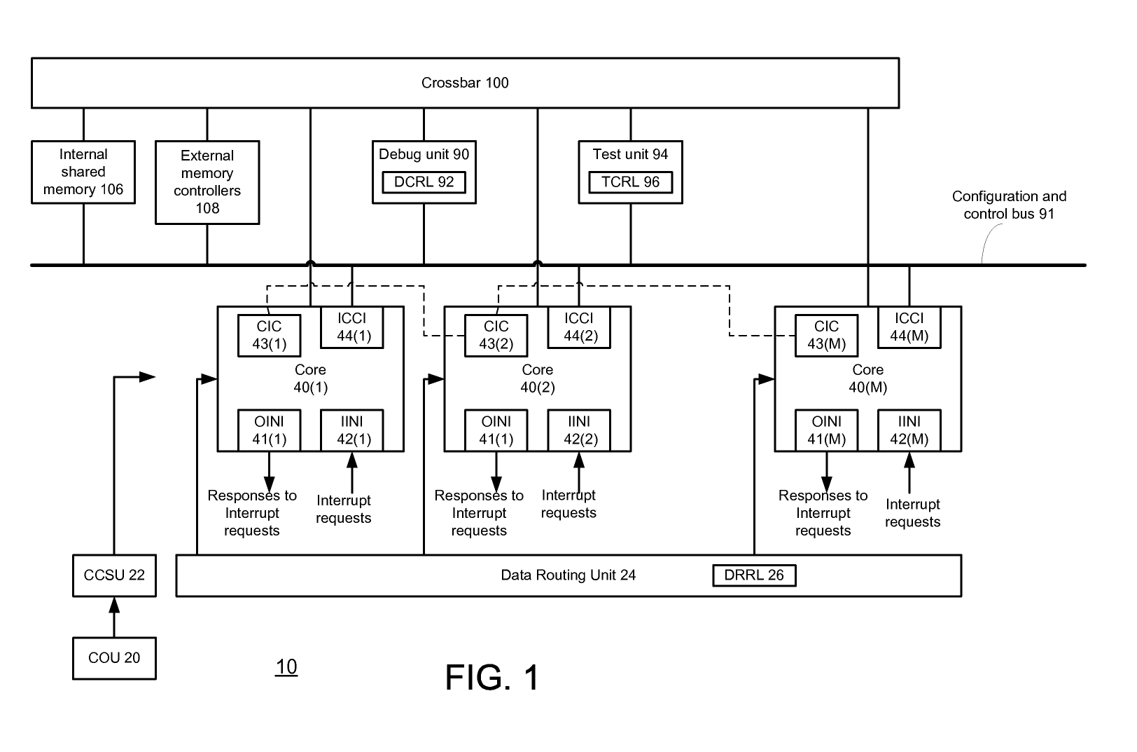

FIG. 1 illustrates device 10 according to an embodiment of the invention. Device 10 includes: (i) multiple cores 40(1)-40(M), (ii) core operability unit (COU) 20, (iii) core control signal unit (CCSU) 22, (iv) crossbar 100, (v) debug unit 90; (vi) test unit 94, (vii) configuration and control bus 91, (viii) external memory controllers 108, (ix) internal shared memory 106, and (x) data routing unit 24.

Configuration and control bus 91 as well as crossbar 100 are connected to cores 40(1)-40(M), to debug unit 90, to test unit 94, to external memory controllers 108, and to internal shared memory 106.

Each core out of cores 40(1)-40(M) is also connected to CCSU 22 and COU 20, to data routing unit 24 and is also adapted to receive multiple interrupt requests and to output a response to interrupt requests via additional control lines.

COU 20 is adapted to indicate an operability of each core out of the multiple cores. It can include a single one time programmable element per physical core that can be burnt to indicate that the core is faulty (or vice verse).

COU 20 provides core operability signals such as core 40(1) operability signal till core 40(M) operability signal. These signals are provided to CCSU 22 and to CIC(1)-CIC(M).

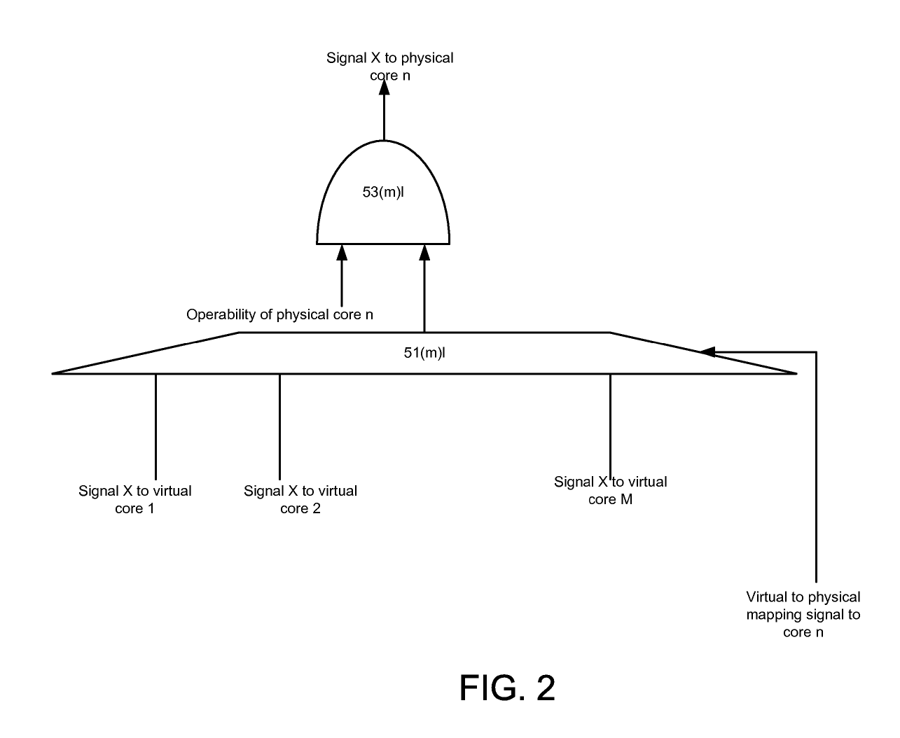

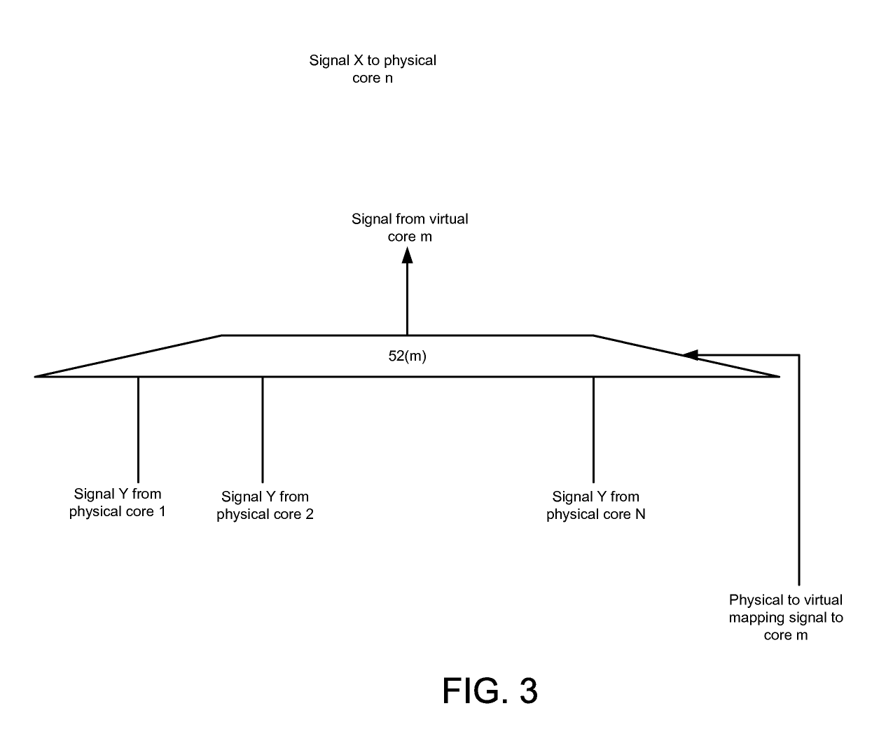

CCSU 22 is adapted to provide mapping signals that include virtual core to physical core mapping signals and physical core to virtual core mapping signals. Physical core to virtual core mapping signals indicate physical cores that act as certain virtual cores. These mapping signals are used to select an output signal from a core, as illustrated in FIG. 3. Virtual core to physical core mapping signals indicate virtual cores that are implemented by physical cores. These mapping signals are used to select an input signal to a core, as illustrated in FIG. 2.

For example, if N=4 and the second physical core (core 40(2)) is inoperative then the first physical core 40(1) will act as the first virtual core, the third physical core 40(3) will act as a second virtual core, and the fourth physical core 40(4) will act as a third virtual core. The virtual core to physical core mapping signals of 40(1), 40(3) and 40(4) will indicate that these physical cores act, respectively, as the first till third virtual cores. The physical core to virtual core mapping signals of the first till third virtual cores will indicate that they are implemented by cores 40(1), 40(3) and 40(4) respectively.

Crossbar 100 is connected to cores 40(1)-40(M) that usually are defined as crossbar masters (initiators). Crossbar 100 includes memory spaces allocated to different masters as well as includes address buses that convey addresses that are (at least initially) designed according to the physical connection between the crossbar and the physical cores. In order to re-map the memory space as well as to provide the appropriate addresses crossbar 100 includes a crossbar core redundancy logic (SCCRL) 104.

Data routing unit 24 provides data to cores 40(1)-40(M) it can also output data from cores 40(1)-40(M). The inventors used crossbar 100 to exchange information within various components of device 10 while data routing unit 24 was used to exchange data with external components.

Data routing unit 24 includes a data routing redundancy logic (DRRL 26) that performs address translation as optionally bus line translation (if various data bus lines are dedicated per core).

Debug unit 90 includes debug control redundancy logic (DCRL) 92 and test unit 94 includes test control redundancy logic (TCRL) 96 that send test and debug signals as well as receive signals from cores, according to the mapping between virtual and physical cores.

DRRL 26, SCCRL 104, ONIN 41(1)-41(M), IINI 42(1)-IINI 42(M), CIC 43(1)-43(M), CCI 44(1)-44(M), TCRL 96 and DCRL 92 are responsive to the mapping signals, thus providing a device that can seamlessly replace a non-operative core by an operative core, while maintaining virtual cores.

If one of these circuits has to send a signal to a core then it includes a virtual to physical core multiplex logic and if one of these circuits has to receive a signal from a core than it will include a physical to virtual core multiplex logic.

Each core (such as core 40(M), wherein n is an index that can range between 1 and N) includes a core identification circuit (CIC) 43(M), an input interrupt interface (IINI) 42(M), an output interrupt interface (OINI) 41(M), and a command and control bus interface (CCBI) 44(M). CIC 43(M) assigns a virtual identification value to the core. The core will act as if his identification number is the number supplied by its core identification circuit. IINI 42(M) receives all the interrupt requests aimed to all physical cores and selects the interrupt request that is associated with its virtual identification number. IINI 42(M) ignores interrupt requests in response to at least one virtual core to physical core mapping signal. OINI 41(M) is adapted to output a response to an interrupt request in response to at least one physical core to virtual core mapping signal. CCBI 44(M) is adapted to exchange control signals with control and configuration bus 91 in response to the virtual identification number of core 40(M) or in response to mapping signals.

FIG. 2 illustrates virtual to physical core multiplex logic 55(n), according to an embodiment of the invention.

Virtual to physical core multiplex logic 55(n) includes multiplexer 51(n) and AND gate 53(n). Multiplexer 51(n) includes M data inputs and a control input. The M data inputs receive the same type of signal that are aimed to the different cores “signal X to virtual core 1” till “Signal X to virtual core M” and in response to a mapping signal “Virtual core to physical core n mapping signal” selects one of these input signals. The output of multiplexer 51(n) is provided to AND gate 53(n) that also receives a signal indicating the operability of that core, such as to avoid sending signals to non-operable cores. It is noted that the signal can be a data signal, a control signal, a configuration signal and the like and that each data input can be a single bit input or a multiple bit input.

FIG. 3 illustrates physical to virtual core multiplex logic 52(2), according to an embodiment of the invention.

Physical to virtual core multiplex logic 52(n) is a multiplexer that includes M data inputs and a control input. The M data inputs receive the same type of signal from operable cores of physical cores 40(1)-40(M) “Signal Y from physical core 1” till “Signal Y from physical core M” and in response to a mapping signal “Physical core to virtual core mapping signal” selects one of these output signals and provides a selected output signal from virtual core n.

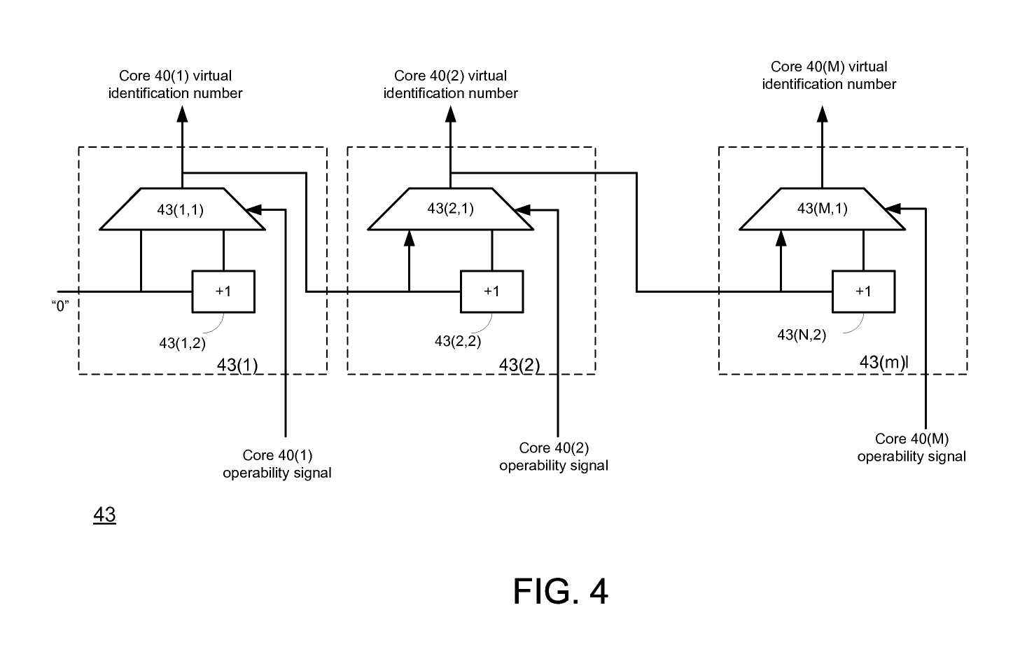

FIG. 4 illustrates core identification logic 43, according to an embodiment of the invention.

Core identification logic 43 includes a chain of core identification circuits 43(1)-43(M), each located within a physical core.

The core identification logic 43 enables to assign consecutive identification numbers to consecutive operable cores.

First CIC 43(1) includes multiplexer 43(1,1) that has two data inputs and one control input. The control input receives core 40(1) operability signal. The first input receives a constant (for example “0”) and the second input receives that constant plus one (the one is added by adder 43(1,2). If core 40(1) is operable the virtual number assigned to core 40(1) will be that constant plus one. If core 40(1) is non-operable then core 40(1) is assigned with an invalid identification number and the next operable core will receive a virtual number that equals that constant plus one.

By connecting the different CICs in a serial manner consecutive virtual identification numbers are assigned to consecutive operable cores.

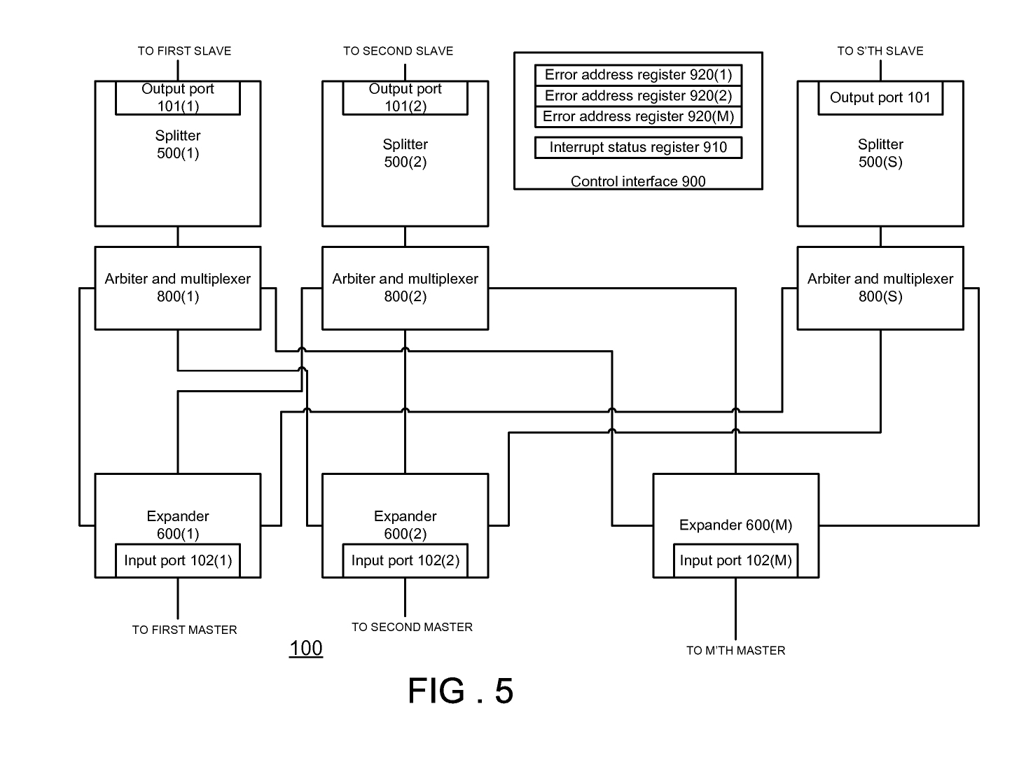

FIG. 5 illustrates interconnect 100 connected to the multiple cores, according to an embodiment of the invention;

Interconnect 100 can include various building blocks, such as expanders, splitters, sampler, clock separators, and the like.

An expander allows a single master with a point-to-point interface to access a plurality of slaves, each with a point-to-point interface. The slave selection is based upon address decoding. Arbiter and multiplexer 800 allows a plurality of masters with a point-to-point interface to access a single slave with a point-to-point interface.

A splitter allows a single master with a point-to-point interface to access a single slave with a point-to-point interface. The splitter 500 optimizes transactions according to the capabilities of the slave.

A sampler allows a single master with a point-to-point interface to access a single slave with a point-to-point interface. It samples the transactions generated towards the slave. It is noted that the sampler 700 as well as other components can include one or more sampling circuits and optionally one or more bypassing circuit.

A clock separator allows a single master with a point-to-point interface to access a single slave with a point-to-point interface. The master may operate in one clock domain while the slave operates in another clock domain.

A bus width adaptor allows a single master with a point-to-point interface to access a single slave with a point-to-point interface. The master's data bus width is different than the slave's data bus width.

Interconnect 100 connects between M masters and S slaves. M and S are positive integers. The M masters are connected to M input ports 102(1)-102(M) while the S slaves are connected to output ports 101(1)-101(S). These input and output ports can support bi-directional traffic between masters and slaves. They are referred to input and output ports for convenience only. Conveniently, the input ports 102(1)1-102(M) are the input interfaces of the expanders 600(1)-600(M) and the output ports are the output interfaces of splitters 500(1)-500(S).

These masters are cores 40(1)-40(M). If some cores are inoperable then interconnect 100 must re-rout signals according to the operability of the cores and their virtual identification numbers.

Interconnect 100 includes M expanders 600(1)-600(M), S arbiters and multiplexers 800(1)-800(S) and S splitters 500(1)-500(S). Each expander includes a single input port and S outputs, whereas different outputs are connected to different arbiter and multiplexers.

Each arbiter and multiplexer 800 has a single output (that is connected to a single splitter) and M inputs, whereas different inputs are connected to different expanders 600. Each splitter 500 is connected to a slave.

It is noted that interconnect 100 can have different configuration than the configuration illustrated in FIG. 2. For example, it may include multiple samplers 700, clock separators 300 and bus width adaptors 400. These components can be required in order to support interconnects to slaves and masters that have different bus widths and operate in different frequencies.

Each splitter 500 is dedicated to a single slave. This splitter 500 can be programmable to optimize the transactions with that slave. Conveniently, each splitter 500 is programmed according to the slave maximal burst size, alignment and critical-word-first (wrap) capabilities.

Each modular components of the interconnect 100 has a standard, point to point, high performance interface. Each master and slave is interfaced via that interface. These interfaces use a three phase protocol. The protocol includes a request and address phase, a data phase and an end of transaction phase. Each of these phases is granted independently. The protocol defines parking grant for the request and address phase. The data phase and the end of transaction phase are conveniently granted according to the fullness of the buffers within the interconnect 100. The request is also referred to as transaction request. The end of transaction phase conveniently includes sending an end of transaction (EOT) indication.

For example, a master can send a write transaction request to an expander 600(1). The expander 600(1) can store up to three write transaction requests, but can receive up till sixteen write transaction requests, as multiple transaction requests are stored in other components of the interconnect. Thus, if it received the sixteenth write transaction request (without receiving any EOT or EOD signal from the master) it sends a busy signal to the master that should be aware that it can not send the seventeenth transaction request.

On the other hand, when the expander 600(1) stores the transaction request it sends an acknowledge to the master that can enter the data phase by sending data to the expander 600(1). Once the expander 600(1) ends to receive the whole data it sends a EOD signal to the master that can then end the transaction.

The expander 600(1) sends the transaction request to the appropriate arbiter and multiplexer. When the transaction request wins the arbitration and when the multiplexer and arbiter receives a request acknowledge signal then expander 600(1) sends the data it received to the splitter. Once the transmission ends the expander 600(1) enters the end of transaction phase. The splitter then executes the three-staged protocol with the target slave.

Interconnect 100 includes a control interface 900 that is able to perform address conversion and memory space conversion, according to the operability of the different cores.

The operation of the device will be further be illustrated by the following examples.

The first example illustrate an access to an erroneous address. It is assumed that core 40(2) acts as the first core (core 40(1) is not functional). Core 40(2) accesses crossbar 100 through expander 102(2) that is physically connected to core 40(2). A wrong address (Associated with physical core 40(2) and not with the first virtual core) is generated, thus and erroneous transaction is generated. Expander 102(2) identifies the error and indicate it to interrupt status register 910 within control interface 900 while returning error indication towards core 40(2).

Expander 102(2) captures the erroneous address in error address register 920(2) (also within control interface 900). Expanders 102(1)-102(M) are associated with error address registers 920(1)-920(M).

The error is captured in the second bit of interrupt status register 910, and a global error interrupt is generated towards cores 40(1)-40(M). Each core reads interrupt status register 910. The second bit of that address will be associated with the first virtual core thus it will be associated with the first virtual core. The first virtual core will access error address register 920(2) and find that an error occurred. Cores 40(1)-40(M) can access these registers via control bus 91. The address manipulations are performed by multiplexes such as those illustrated in FIG. 2 and FIG. 3.

It is noted that an address manipulation should take place as error address register 920(2) should be accesses as if it is the first error address register. Reading bits within registers also involves manipulations.

The next example illustrated how debut and profiling operate. Assuming that the traffic between a certain slave and first virtual core should be monitored. Actually, this should result in monitoring the traffic between physical core 40(2) and that slave. (It is noted that the same applies if a watch point should be placed on first virtual core). While debut unit 90 and test unit 94 will be programmed to monitor first core 40(1) the core redundancy circuits will monitor second core 40(2) that operates as the first virtual core.

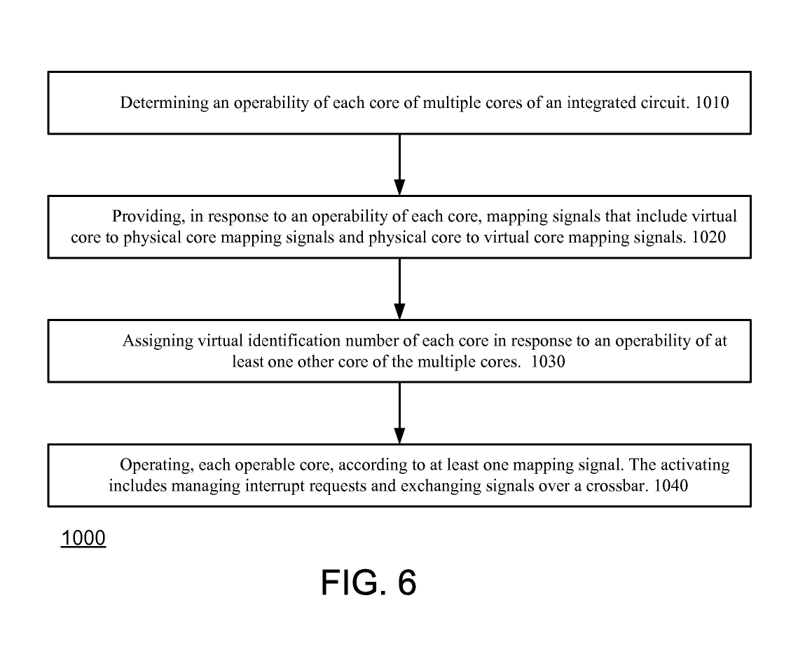

FIG. 6 illustrates method 1000 for providing core redundancy, according to an embodiment of the invention.

Method 1000 starts by stage 1010 of determining an operability of each core of multiple cores of an integrated circuit. This stage can be before the device is shipped to the market. Conveniently, one time programmable components are programmed to reflect the operability of each core. Referring to the example set fourth in previous drawings, these one time programmable components are included within COU 20.

Stage 1010 is followed by stage 1020 of providing, in response to an operability of each core, mapping signals that include virtual core to physical core mapping signals and physical core to virtual core mapping signals.

Referring to the example set fourth in previous drawings, these signals can be provided by CCSU 22 and are sent to various components such as but not limited to DRRL 26, SCCRL 104, ONIN 41(1)-41(M), IINI 42(1)-IINI 42(M), CIC 43(1)-43(M), CCI 44(1)-44(M), TCRL 96 and DCRL 92. Referring to FIG. 2 and FIG. 3 these mapping signals control virtual to physical core multiplex logic 55(n) and physical to virtual core multiplex logic 52(2).

Stage 1020 is followed by stage 1030 of assigning virtual identification number of each core in response to an operability of at least one other core of the multiple cores. Conveniently, stage 1030 includes assigning consecutive identification numbers to consecutive operable cores. Referring to the example set fourth in previous drawings, stage 1030 can be implemented by CIC 43(1)-43(M).

Stage 1030 is followed by stage 1040 of operating, each operable core, according to at least one mapping signal; wherein the activating includes managing interrupt requests and exchanging signals over a crossbar.

Stage 1040 can include at least one of the following: (i) receiving interrupt requests aimed to any core of the multiple cores; and ignoring an interrupt request in response to at least one virtual core to physical core mapping signal; (ii) outputting a response to an interrupt request in response to at least one physical core to virtual core mapping signal; (iii) receiving configuration signals in response to at least one mapping signal; (iv) receiving mapping signals and in response altering address values exchanged over the crossbar; (v) exchanging signals, during a debug mode, between a debug unit and multiple operable cores, in response to at least one mapping signal; (vi) exchanging signals, during a test mode, between a test unit and multiple operable cores, in response to at least one mapping signal.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. A device having redundant cores, the device comprises
multiple cores;
a core operability unit adapted to indicate an operability of each core out of the multiple cores; and
a core control signal unit adapted to provide mapping signals that comprise virtual core to physical core mapping signals and physical core to virtual core mapping signals;
wherein each core out of the multiple cores comprises at least one interrupt interface, and a crossbar interface which are responsive to at least one mapping signal.

2. The device according to claim 1 wherein at least one core out of the multiple cores comprises a core identification circuit adapted to determine a virtual identification number of the core in response to an operability of at least one other core of the multiple cores.

3. The device according to claim 2 wherein core identification circuits of different cores are coupled to each other in a serial manner such as to assign consecutive identification numbers to consecutive operable cores.

4. The device according to claim 1 wherein an input interrupt interface of a core is adapted to receive interrupt requests aimed to any core of the multiple cores and to ignore an interrupt request in response to at least one virtual core to physical core mapping signal.

5. The device according to claim 1 wherein an output interrupt interface of a core is adapted to output a response to an interrupt request in response to at least one physical core to virtual core mapping signal.

6. The device according to claim 1 wherein each core further comprises a configuration interface responsive to at least one mapping signal.

7. The device according to claim 1 wherein the device comprises a crossbar that comprises a core redundancy adaptation unit adapted to receive mapping signals and in response alter address values exchanged over the crossbar.

8. The device according to claim 1 wherein the device comprises a debug unit adaptation circuit adapted to receive at least one mapping signal and in response alter debug signals exchanged during a debut sequence.

9. A method for providing core redundancy, the method comprises:
determining an operability of each core of multiple cores of an integrated circuit;
providing, in response to an operability of each core, mapping signals that comprises virtual core to physical core mapping signals and physical core to virtual core mapping signals; and
operating each operable core, according to at least one mapping signal;
wherein the operating comprises managing interrupt requests and exchanging signals over a crossbar.

10. The method according to claim 9 further comprising assigning virtual identification number of each core in response to an operability of at least one other core of the multiple cores.

11. The method according to claim 10 wherein the assigning comprises assigning consecutive identification numbers to consecutive operable cores.

12. The method according to claim 9 wherein the operating comprises:
receiving interrupt requests aimed to any core of the multiple cores; and
ignoring an interrupt request in response to at least one virtual core to physical core mapping signal.

13. The method according to claim 9 wherein the operating comprises outputting a response to an interrupt request in response to at least one physical core to virtual core mapping signal.

14. The method according to claim 9 wherein the operating further comprising receiving configuration signals in response to at least one mapping signal.

15. The method according to claim 9 wherein the operating comprises receiving mapping signals and in response altering address values exchanged over the crossbar.

16. The method according to claim 9 wherein the operating comprises exchanging signals, during a debug mode, between a debug unit and multiple operable cores, in response to at least one mapping signal.

17. The method according to claim 10 wherein the operating comprises:
receiving interrupt requests aimed to any core of the multiple cores; and
ignoring an interrupt request in response to at least one virtual core to physical core mapping signal.

18. The method according to claim 10 wherein the operating further comprising receiving configuration signals in response to at least one mapping signal.

19. The method according to claim 10 wherein the operating comprises exchanging signals, during a debug mode, between a debug unit and multiple operable cores, in response to at least one mapping signal.

20. The device according to claim 2 wherein an input interrupt interface of a core is adapted to receive interrupt requests aimed to any core of the multiple cores and to ignore an interrupt request in response to at least one virtual core to physical core mapping signal.
